(19) United States
(12) Patent Application Publication
(10) Pub. No.: US 2005/0255406 A1
(43) Pub. Date: Nov. 17, 2005

(54) Marking on a thin film

(76) Inventor: Shlomo Assa, San Diego, CA (US)

Correspondence Address: FISH & RICHARDSON, PC, 12390 EL CAMINO REAL, SAN DIEGO, CA, 92130-2081, US

(21) Appl. No.: 11/126,453

(22) Filed: May 10, 2005

Related U.S. Application Data
(60) Provisional application No. 60/570,315, filed on May 11, 2004.

(51) Int. Cl. G03C 1/492

(52) U.S. Cl. 430/270.1

(57) ABSTRACT

A technique of applying a protective layer and an absorbing layer to a wrapping material for wrapping a product, such as a candy bar or potato chips. The protective layer prevents a laser marking tool from puncturing the film. The absorbing layer absorbs radiation from the laser marking tool to show a sequence of symbols and characters, such as a date, bar codes, an image or a logo. Another technique for marking codes on a thin film may include applying a thermal coating or ink on a thin film. A device with a ribbonless, non-contact thermal print head may apply heat to specific portions of the thermal coating to mark symbols and characters. The portions of the thermal coating exposed to heat will change color.

### CROSS-REFERENCE TO RELATED APPLICATIONS

This application claims benefit of the priority of U.S. Provisional Application No. 60/570,315, filed May 11, 2004.

### BACKGROUND

Modern production practices often involve printing an identification code on commercial products and containers. These codes are easily observed on common products, such as food products, soda cans, cosmetics, and pet food containers. Some government regulatory agencies, such as the Food and Drug Administration, may require certain products to have such codes.

These codes often include information that is unique to the time and place at which the product is manufactured. For instance, many codes communicate a batch number associated with a product. Many codes go further and indicate the actual time and date of manufacture. Because some codes relate to unique manufacturing parameters (e.g., time and date), some codes cannot be pre-printed on a label for a product. Hence, a code is often printed on the label after the product is manufactured. Current code printing technology includes the use of ink jets, which spray ink onto the label.

### SUMMARY

A laser system may be used to mark characters or symbols on a thin film used to wrap products such as potato chips, candy bars and other food. But the laser system may puncture the thin film if the laser is too powerful, a dwell time of the laser is too long, or the film is not suitable for laser marking.

One technique for marking codes on a thin film includes forming a protective layer and a radiation absorbing layer on the thin film. The protective layer prevents a laser marking tool from puncturing the film. The radiation absorbing layer absorbs radiation from the laser marking tool to form a code or sequence of symbols and characters, such as a date, a location, bar codes, a graphic image or a logo.

An aspect of the technique relates to a method of forming a wrapping material. The method comprises forming a protective layer over an initial layer. The protective layer substantially prevents a marking laser beam from puncturing the initial layer. The method further comprises forming a radiation absorbing layer over the protective layer to absorb radiation from the marking laser beam.

Another aspect relates to a wrapping material, which comprises an initial layer, a protective layer and a radiation absorbing layer. The protective layer is formed over the initial layer. The protective layer has a property to substantially prevents a laser beam from puncturing the initial layer. The protective layer can be a radiation reflecting layer, which reflects laser light away from the initial layer. This radiation reflecting layer an be a thin layer made using silver or aluminum material. The radiation absorbing layer is formed over the protective layer. The radiation absorbing layer has a property to absorb radiation from the laser beam. This radiation absorbing layer can be a thin layer made using carbon and/or graphite material. Moreover, the radiation absorbing layer can be used to turn laser energy into heat at a location on the wrapping material, which can then activate a thermal coating or ink in the wrapping material.

Another aspect relates to a system to form a material used to wrap a product. The system comprises a first unit and a second unit. The first unit forms a protective layer over an initial layer. The protective layer has a property that substantially prevents a laser beam from puncturing the initial layer. The second unit forms a radiation absorbing layer over the protective layer. The radiation absorbing layer having a property to absorb radiation from the laser beam.

The multi-layer film has an advantage of protecting the product wrapped inside the film from exposure to outside air and contaminants.

Another technique for marking codes on a thin film may include applying a thermal coating or ink on a thin film. A device with a ribbonless, non-contact thermal print head may apply heat to specific portions of the thermal coating to mark symbols and characters. The portions of the thermal coating exposed to heat will change color. This technique may use relatively inexpensive printers and reduce costs of marking thin film wrappers. This technique may avoid expensive and cumbersome contact thermal transfer devices and expensive thermal print ribbons. Ribbon advance mechanisms and contact pressure have been known to cause failures, film breaks and down time in manufacturing. Thus, ribbonless, non-contact thermal printing may avoid or reduce these problems.

An aspect of the second technique relates to a method of forming a wrapping material. The method comprises forming a sheet of film and applying a thermal coating on the film. The coating is responsive to an increase in temperature to change an optical characteristic.

Another aspect of the second technique relates to a system to form a wrapping material. The system comprises a device to create a film from several layers of material. The film is suitable to wrap a product. The system further comprises an applicator to apply a thermal coating on the film. The thermal coating is responsive to an increase in temperature to change a visual appearance.

Details one or more implementations are set forth in the accompanying drawings and the description below. Other features and advantages may be apparent from the description, drawings and/or claims.

### BRIEF DESCRIPTION OF THE DRAWINGS

FIG. 1 is a side view of a laser marking system.

FIG. 2 illustrates the laser marking system of FIG. 1 marking in a desired area on a product.

FIG. 3A is a side view of a laser marking beam being incident on a material with multiple layers at a location where a spot is to be formed on the material.

FIG. 3B is a perspective view of the laser marking beam of FIG. 3A being incident on the material at the location where the spot is to be formed on the material.

FIG. 3C is a side view of the material of FIG. 3A after the laser marking beam has formed a spot in the material.

FIG. 3D is a perspective view of the material of FIG. 3C after the laser marking beam has formed the spot in the material.

FIG. 3E illustrates an initial layer, a protective layer, an absorbing layer and another protective layer.

FIG. 4 is a flow diagram of a method to form a multi-layer material.

FIG. 5 illustrates a technique of ribbonless, non-contact thermal marking on a film used for wrapping or packaging products.

FIG. 6 illustrates components of the technique in FIG. 5.

### DETAILED DESCRIPTION

The disclosure relates to a method of applying a protective layer and a radiation absorbing layer to a wrapper used to wrap a product such as a candy bar or potato chips. The protective layer prevents a laser marking tool from puncturing the wrapper. The radiation absorbing layer absorbs radiation from the laser marking tool to mark a sequence or code of symbols and characters, such as a date, bar codes, an image or a logo. An additional protective layer may be added on top of the absorbing layer.

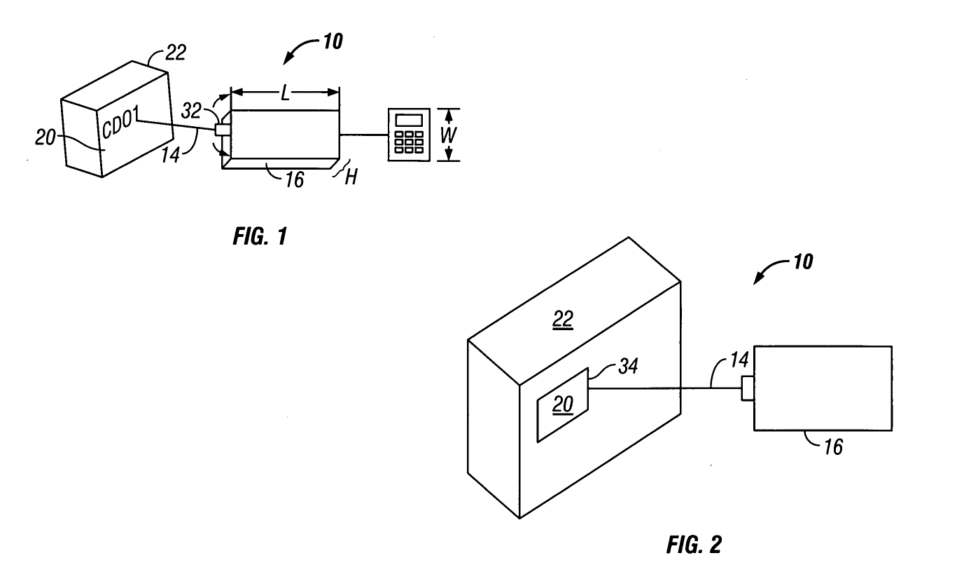

FIG. 1 illustrates a laser marking system 10 for marking on a product 22 positioned adjacent to the laser marking system 10. For example, the laser marking system 10 may be a SmartLase™ laser marking system made by Markem Corporation of Keene, N.H. The laser marking system 10 includes a laser 16 for producing a marking beam 14. Any laser 16 can be used in the laser marking system 10. The laser 16 may be a relatively low power laser. For example, the laser 16 may be a 10-watt, 15-watt, 20-watt or 30-watt laser.

The laser marking system 10 can mark symbols which are from word processing programs, such as alphanumeric symbols and any other symbols used to identify a product batch, date, etc. The code can be readable text such as product names or identifiers. The code need not be alphanumeric and can include symbols which are not produced by typical word processing programs. For instance, the code can be a bar code.

The products for use with the laser marking system 10 can be products to be sold retail or packaging of retail products. Further, the products can be products which are sold to other businesses. Examples of products include pharmaceuticals, pharmaceutical packaging, food packaging, cosmetics, food such as eggs, dairy products, ice cream, computer components, automotive components, medical devices, detergents and beverages such as soft drinks and wines.

The code can be formed in multiple locations on a product. For instance, plastic medicine bottles can have one code marked directly on the plastic bottle and another code formed on the label attached to the plastic bottle.

The code may be formed from a plurality of laser-marked spots. A spot is formed on the product by altering an optical characteristic of the material at the location where the marking beam is incident on the product. The marking beam can alter a variety of optical characteristics of a product. For instance, the marking beam can cause one or more layers of material to be ablated so the underlying layers are visible. Since upper layers of a material often have an ink layer on paper, removal of the ink layer leaves a spot where the paper is visible against the surrounding ink layer. The refractive characteristics of a material can also be altered. For instance, the marking beam can be used to mark a code on a plastic such as a soft drink bottle. The marking beam alters the refractive characteristics of the plastic. The code is easily visible since the eye can pick up the sections having contrasting refractive properties. In addition, the marking beam can etch certain materials.

FIG. 2 illustrates an example of the laser marking system 10 marking in a desired area 34 on a product 22. The laser marking system 10 forms a symbol of a code within the desired area 34. The laser beam 14 forms a plurality of spots at a variety of locations on the product 22 by remaining at the location until an optical characteristic of the location is altered.

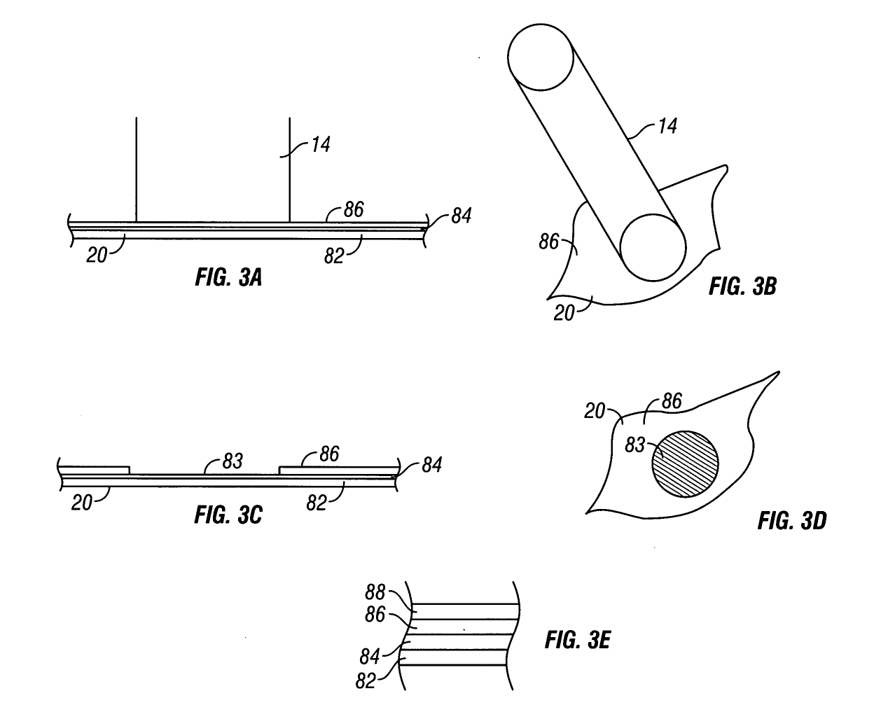

FIGS. 3A-3D illustrate a laser beam 14 forming a spot 83 on a material 20 by removing a radiation absorbing layer 86 from the material 20 or at least altering an optical characteristic of the radiation absorbing layer 86. FIGS. 3A and 3B illustrate the laser beam 14 incident on the material 20 at a particular location, which forms a spot 83 (FIG. 3C) on the material 20. The material 20 includes an initial layer or substrate 82, which may be made of plastic, metal, tin foil, paper, fiberglass, etc. The substrate 82 may be a thin film rolled up or spread as a sheet, which may be later cut into smaller pieces. The smaller pieces may be used to wrap individual products, such as candy, potato chips and other food products.

A protective layer 84 is formed over the substrate 82. The protective layer 84 may be a thin film or coating of paint, plastic, metal, paper, etc. The protective layer 84 may have mechanical or chemical properties that prevent the laser beam 14 from puncturing the substrate 82. The protective layer 84 may reflect some or all of the laser beam 14. The protective layer 84 may be selected or made to reflect a laser with a specific wavelength.

The radiation absorbing layer 86 is formed over the protective layer 84. The radiation absorbing layer 86 may have mechanical or chemical properties to absorb at least some radiation from the incident laser beam 14. The radiation absorbing layer 86 may be a thin film of plastic, metal, adhesive, paint, wax, etc. The radiation absorbing layer 86 can be a wax layer which protects a packaging and gives the packaging an attractive appearance. The radiation absorbing layer 86 can include several different ink types as well as several different colors used on labels of many commercially available products.

The substrate 82 may be moving on an assembly or production line while the layers 84 and 86 are formed. The layers 84, 86 may be formed on the substrate 82 in the same assembly line as the laser marking unit 10 or in a separate process or production location.

FIGS. 3C-3D illustrate the material 20 after the spot 83 has been formed at the particular location on the material 20. The time that the printing beam 14 dwells at the particular location may be adjusted such that the printing beam 14 has ablated the radiation absorbing layer 86 from the material 20 without,burning the substrate 82. After the laser marking, the protective layer 84 and/or the substrate 82 are visible at the particular location on the material 20.

FIG. 3E illustrates a substrate 82, a first protective layer 84, a radiation absorbing layer 86 and a second protective layer 88. The second protective layer 88 may prevent scratching or erosion of the radiation absorbing layer 86. The second protective layer 88 may absorb radiation from the laser beam 14 or be transparent to the laser beam 14 such that the laser beam passes through the second protective layer 88 to the radiation absorbing layer 86.

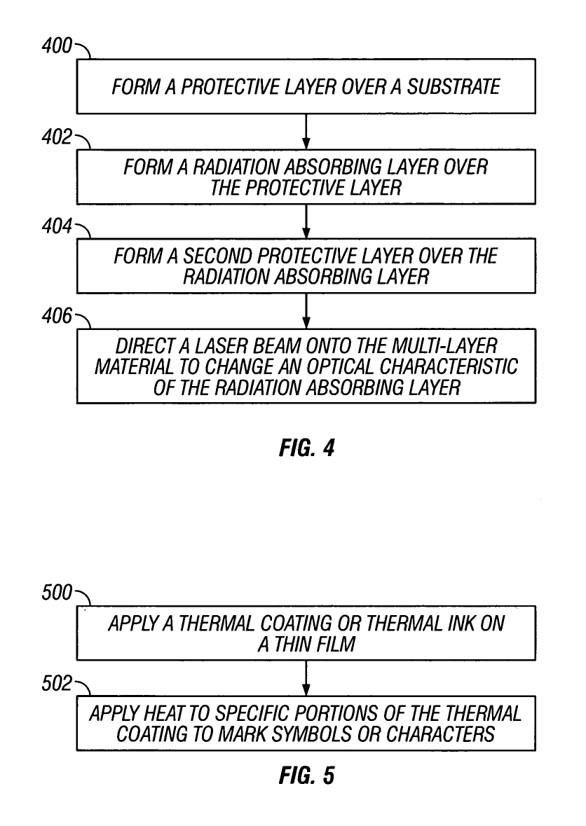

FIG. 4 is a flow diagram for forming the multi-layer material 20 described above. In a block 400, a protective layer is formed over a substrate. In a block 402, a radiation absorbing layer is formed over the protective layer. In a block 404, a second protective layer is formed over the radiation absorbing layer. The layers may be formed over each other by spraying, coating, adhesive or other methods. In a block 406, the laser marking system 10 (FIG. 1) generates, directs and/or focuses a laser beam 14 onto the multi-layer material to change an optical characteristic of the radiation absorbing layer.

Ribbonless, Non-Contact, Thermal Marking on Film

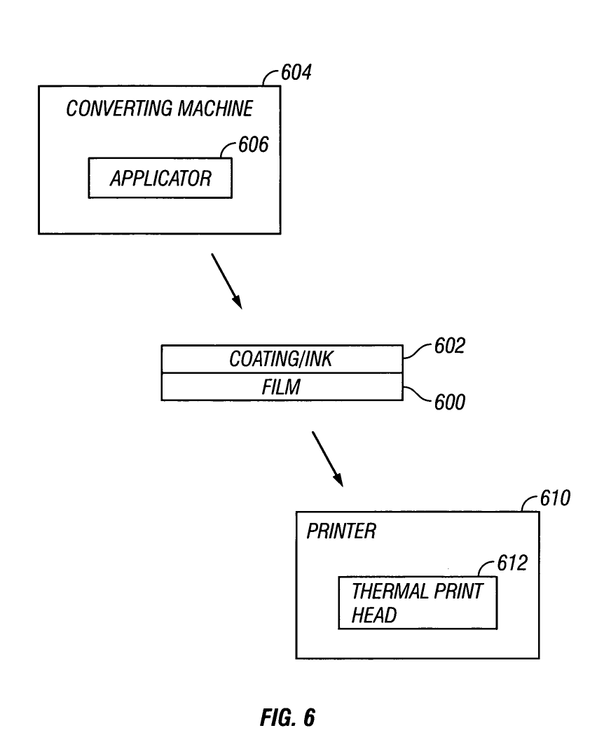

FIG. 5 illustrates a technique of ribbonless, non-contact thermal marking on a film used for wrapping or packaging products such as food, e.g., candy, potato chips and other snacks. Ribbonless thermal printing may also be referred to as “direct thermal printing” where an “ink” is formed on or in a media to be marked. FIG. 6 illustrates components of the technique of FIG. 5. In block 500 of FIG. 5, a thermal coating or thermal ink 602 is applied on a thin film 600. The thermal coating or thermal ink 602 may be obtained from Appleton of Appleton, Wis. Alternatively, other coatings, inks and compositions may be used that change color or appearance upon exposure to a threshold temperature or increase in temperature.

A converting machine or device 604 in FIG. 6 creates the film 600 from several layers. The film 600 may be a laminated film. The film 600 may be plastic and relatively non-porous compared to paper. The converting machine 604 may operate with an applicator 606, which may be separate or integrated in the converting machine 604. The applicator 606 applies the thermal coating or ink 602 onto the film 600. The thermal coating or ink 602 may have a chemical property that allows it to bond with the film 600. Alternatively, the coating or ink 602 may be bonded to an intermediate layer that is bonded to the film 600.

In block 502, a printer 610 with a ribbonless, non-contact thermal print head 612 may apply heat to specific portions of the thermal coating 602 to mark codes, symbols, characters, images, etc. The portions of the thermal coating 602 exposed to heat will change color or some visually noticeable optical characteristic. The printer 610 and thermal print head 612 may be similar to standard printers and thermal print heads used to print text on thermal coated paper made by Appleton, such as sale receipts and airline tickets. In one configuration, the printer 610 and converting machine 604 may be integrated in a single system. The non-contact thermal printer 610 is different from conventional contact thermal printers, which apply pressure to transfer ink from a ribbon to a material, such as film.

Although the present techniques and devices have been described in detail, it should be understood that various changes, combinations, substitutions and alterations can be made hereto without departing from the spirit and scope of the application as described by the appended claims.

1. A method of forming a wrapping material, the method comprising:
forming a protective layer over an initial layer, the protective layer substantially prevents a marking laser beam from puncturing the initial layer; and
forming a radiation absorbing layer over the protective layer to absorb radiation from the marking laser beam.

2. The method of claim 1 further comprising directing a laser beam on the radiation absorbing layer to change an optical characteristic of the radiation absorbing layer and form a visual pattern.

3. The method of claim 1 wherein the protective layer is formed such that at least a portion of the laser beam is reflected by the protective layer.

4. The method of claim 3 wherein the protective layer is made to reflect a laser with a specific wavelength.

5. The method of claim 1 further comprising wrapping a product with the material.

6. The method of claim 1 further comprising forming a second protective layer over the radiation absorbing layer to protect the radiation absorbing layer.

7. The method of claim 1 further comprising forming an additional layer comprising a thermal coating activated by heat generated when the laser beam interacts with the radiation absorbing layer.

8. The method of claim 1 wherein forming the protective and radiation absorbing layers comprises at least one of spraying, coating, and attaching a material by adhesive.

9. A wrapping material comprising:
an initial layer;
a protective layer formed over the initial layer, the protective layer having a property that substantially prevents a laser beam from puncturing the initial layer; and
a radiation absorbing layer formed over the protective layer, the radiation absorbing layer having a property to absorb radiation from the laser beam.

10. The wrapping material of claim 9 wherein the protective layer is formed such that at least a portion of the laser beam is reflected by the protective layer.

11. The wrapping material of claim 10 wherein the protective layer is selected to reflect a laser with a specific wavelength.

12. The wrapping material of claim 9 wherein the radiation absorbing layer is adapted to be exposed to the laser beam to form a visual pattern.

13. The wrapping material of claim 12 wherein the radiation absorbing layer is adapted to activate a thermal coating by heat generated when the laser beam interacts with the radiation absorbing layer.

14. A method of forming a wrapping material, the method comprising:
forming a sheet of film; and
applying a thermal coating on the film, the coating being responsive to an increase in temperature to change an optical characteristic.

15. The method of claim 14 wherein forming the film comprises creating the film from several layers of material.

16. The method of claim 14 further comprising applying heat to specific portions of the thermal coating to mark a pattern on the thermal coating.

17. The method of claim 16 wherein applying heat to specific portions of the coating to mark a pattern on the coating uses a ribbonless, non-contact, thermal printing device.

18. The method of claim 14 wherein the optical characteristic is a color.

19. The method of claim 14 further comprising cutting the film into a plurality of pieces, and wrapping a product with one of the pieces of film.

20. A system to form a wrapping material, the system comprising:
a device to create a film from several layers of material, the film being suitable to wrap a product; and
an applicator to apply a thermal coating on the film, the thermal coating being responsive to an increase in temperature to change a visual appearance.

21. The system of claim 20, further comprising a ribbonless, non-contact, thermal printing device to mark a pattern on the thermal coating.

22. The system of claim 20, wherein the visual appearance is a color.
